(19) United States
(12) Patent Application Publication
(10) Pub. No.: US 2021/0080235 A1
(43) Pub. Date: Mar. 18, 2021

(54) MOBILE DEVICE SAFETY MECHANISM FOR INDIVIDUALS, GROUPS AND ORGANIZATIONS OF TARGET-SPORT PARTICIPANTS

(71) Applicants: Douglas Marquis, Weston, MA (US); Paul M. Curtis, Sudbury, MA (US)

(72) Inventors: Douglas Marquis, Weston, MA (US); Paul M. Curtis, Sudbury, MA (US)

(21) Appl. No.: 16/573,096

(22) Filed: Sep. 17, 2019

(51) Int. Cl. F41J 5/02; F41J 5/14; A63F 9/02

(52) U.S. Cl. CPC F41J 5/02; A63F 9/0204; F41J 5/14

(57) ABSTRACT

The present invention comprises an automated integrated information management system for individuals or groups. Algorithms, hardware, software, and human-machine interfaces provide the capability to automatically collect, process, display, and record information related to target sports, and allow secondary participants to process, display, analyze, train, interpret, and aggregate. In preferred embodiments, the various segments of the automated integrated information system are all implemented an operating, although some embodiments may choose to implement only a subset or may add ancillary functions to the invention.

### FIELD OF THE INVENTION

The present invention relates to individual and groups of information systems that jointly support target sport participants, individually, in groups, or in organizations from local up to international scale. More particularly, the invention relates to combinations of software and hardware that allow individuals, groups, up to enterprise-scale organizations to automatically collect, process, display, and record information related to target sports, and allow secondary participants to process, display, analyze, train, interpret, aggregate and provide for group-based and organization-based activities surround target sports. Such information would be used for multiple purposes by multiple persons and organizations, including for recording, self-training, analytics, professional training, competitions, advertisement, organization of events, sales of target-sport related materiel including ammunition, targets, guns, archery equipment, and accessories.

The present applications claims priority to the earlier filed provisional application having identification number EFS-ID 33873354, and hereby incorporates subject matter of the provisional application in its entirety.

### BACKGROUND

Target sports in the United States are broadly practiced across the United States. Some recent activity has attempted to provide pieces of information processing equipment associated with supporting individuals performing storage, recording, and limited analysis of targets associated with target sports. These activities have center around separated storage of target information, collection of target information, and limited analysis of target information for individuals.

However, these methods have several drawbacks. With respect to integration existing methods are limited to either mobile devices, or to web-based databases—not to an integrated system encompassing mobile devices, remote processing and storage, purpose-built image collection devices, social media interaction, and additionally not considered currently, organizations (including local organizations such as target shooting ranges, up to enterprise-scale national or international organizations). Manual steps are required of a user to store information collected or processed on a mobile device, and such steps are a safety risk in some target-sport scenarios. This drawback also leads to user inconvenience in using target-sport data.

With respect to a collection method on a mobile device, it is a drawback of existing methods that they do not allow live feedback to allow a user to optimize the data collection, nor do existing methods automate the capture of image information. Both the level of effort and the distraction caused by a lack of live feedback constitute a safety risk for information collection in some target-sport scenarios. Additionally, existing methods are not target-agnostic—requiring a user to select a known target from an offering of targets specified prior to collecting information. Existing methods also do not offer mechanisms to prohibit the handling of a weapon (likely loaded) concurrently with a mobile device, a clear safety-of-human-life risk.

With respect to a collected set of information, a drawback of existing methods is that they have as their display output only a single human consumer—no consideration heretofore has been given to groups of users consuming collected information. This drawback prohibits the automatic inclusion of certain training, competition, group comparison, and other group-based activities without additional manual steps by a collector that are a safety risk in some target-sport scenarios. An additional drawback of not considering groups is that analytics and displays that would be of interest to groups (e.g. clubs, up to state/national/international-scale organizations), or of interest only to groups, have never been created.

Recent software development methods, changes in the economics of remote data storage and processing, and improvements in mobile device technology now allow substantially broader automation, and full integration of a set of capabilities to provide an automated integrated information management system for both individuals, secondary participants, and groups and organizations.

Therefore, a need exists in the field an automated integrated information management system associated with target-sport individuals, groups, and enterprise-scale organizations. A further need exists for mobile devices that automate collection methods that minimize the safety risk of collection and minimize the distractions that may lead to safety risks associated with the information collection. Finally, there is a need for consideration beyond individuals, to include groups of target-sport participants, to be able to exploit and enjoy the benefits of collected target-sport information.

### SUMMARY OF THE INVENTION

The present invention comprises an integrated automated information system containing collection, server, analytic, and group/organization segments. The collection segment is implemented in multiple software instances that operate on commonly available mobile devices including (but not limited to) Android and Apple mobile devices. The server segments are implemented in distinct instances of software operating on servers hosted on a broadly available Internet service address. Custom hardware, as an example range-resident visible-band or infrared cameras, for collection integrated with the other segments of this invention is an alternate embodiment of the collection segment. The analytic segment is implemented in purpose-developed software and hosted in Internet spaces associated with the server segments. The group segment has a distributed implementation, including some software developed on the mobile platform, and some software hosted on Internet resident servers.

### DESCRIPTION OF THE DRAWINGS

Some embodiments of the present invention are illustrated as an example and are not limited by the figures of the accompanying drawings, in which like references may indicate similar elements:

FIG. 1: an information architecture view of the four segments that comprise the initial embodiment of the invention.

FIG. 2: shows a screen capture of the mobile device home screen which serves as a depiction of one portion of the original embodiment of the collection segment of the invention.

FIG. 3: shows a view of the display associated with the datastore of a single collected target, retrieved from the server, in the initial embodiment of the invention.

FIG. 4: depicts a single group analytic associated with the group segment in the initial embodiment of the invention.

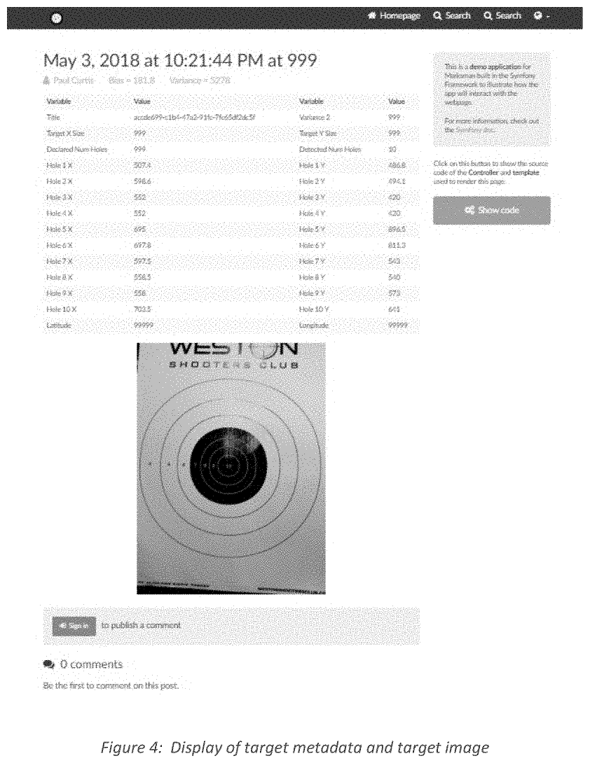

FIG. 5: depicts a group comparison analytic associated with the group segment in the initial embodiment of the invention.

FIG. 6: depicts analytics for trainers across students.

FIG. 7: depicts a safety screen developed as part of a safety mechanism in the initial embodiment.

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise.

It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

New information management methods associated with collecting, processing, re-processing, analyzing, sharing, displaying, storing, conveying, and interpreting are discussed herein. In the following description, for purposes of explanation, numerous specific details are set forth in order to provide an understanding of the present invention. It will be evident, however, to one skilled in the art that the present invention may be practiced without these specific details.

The present disclosure is to be considered as an exemplification of the invention and is not intended to limit the invention to the specific embodiments illustrated by the figures or description below.

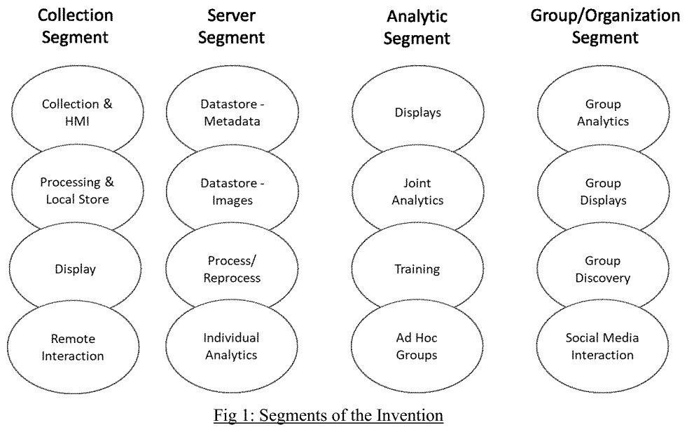

The present invention will now be described by referencing the appended figures representing preferred embodiments. FIG. 1 depicts an information architecture view according to various embodiments of the present invention. In preferred embodiments, each of the segments shown in FIG. 1 exists and operates, although some embodiments may not implement all portions.

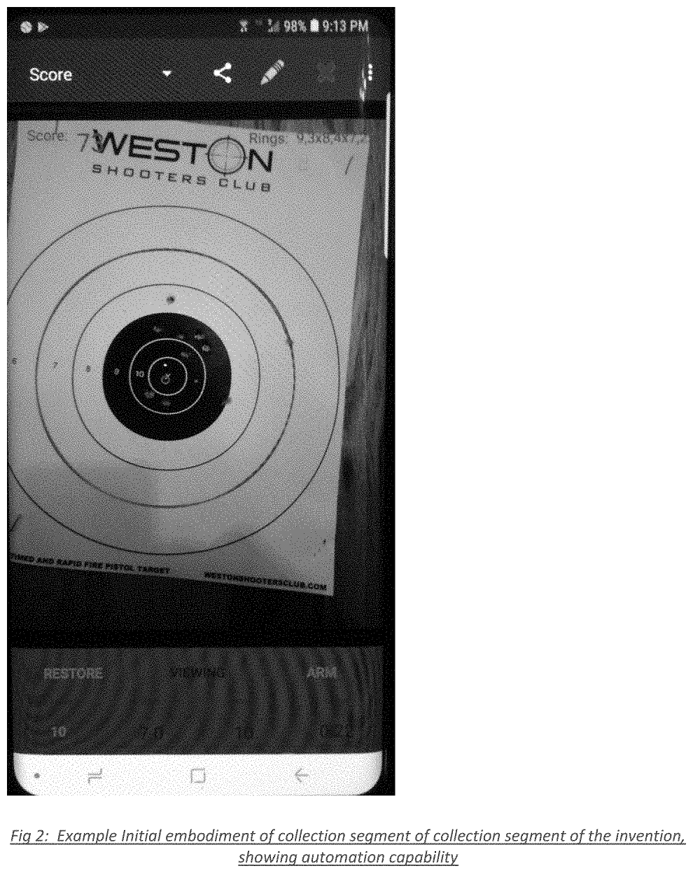

In the collection segment shown in FIG. 2, the ‘collection and HMI’ portion comprises a hardware camera, a hardware display device, and a human-machine interface [“HMI”] capability capable of accepting input from one or more humans. The ‘processing and local store’ portion comprises an information manipulation capability including digital processing, and local and remote memory. The ‘display’ portion provides an ability to render information from local or remote storage, possibly interpreted or analyzed, for interpretation by one or more humans. The ‘remote interaction’ portion provides for communication with other information processing and storage elements within or without the invention. The collection segment initial embodiment is implemented on a commercially available smartphone or tablet. The camera and display hardware in the initial embodiment are those provided by the commercial device. The software application on the device is part of the collection segment, and part of the analytic segment of the initial embodiment of the invention. The software application automatically captures target data by (a) recognizing that the camera in the device has been pointed at a target while rendering a live video feedback of the image to the user providing for assistance in aiming and distance adjustments, (b) providing queues on the display to aid the user in some combination of positioning, aligning the camera with the target and adjusting the range from the camera to the target, lighting, pose, quality feedback, target or projectile information, expected count information, resultant score, or other mechanisms intended to affect user behavior in order to increase the utility of the collection intended by the user, (c) recognizing that the target scene is of sufficient quality to permit an image capture that will reasonably represent the target image to the automated information system and capturing that image at such a moment that the condition exists without additional operator action—unqueued capture, (d) performing image processing upon the captured image that extracts the location of the target markings and projectile or projectiles, whether they be arrows, bullets, or other projectiles, with respect to the target markings and thereby with appropriate additional calculations creating target metadata, (e) providing unqueued local and remote storage of both target metadata and captured images including to the server segment shown in FIG. 1, (f) providing unqueued integration into any organization, group, or individual additional information along with the captured target image and created target metadata as is relevant for the configuration set by the individual, group, or organization, including but not limited to, registering target metadata or target images with local, group, regional, distributed, or national/international competitions, external databases or datastores, self-training or other training forums, friends, social media, or to advertising or sales functions.

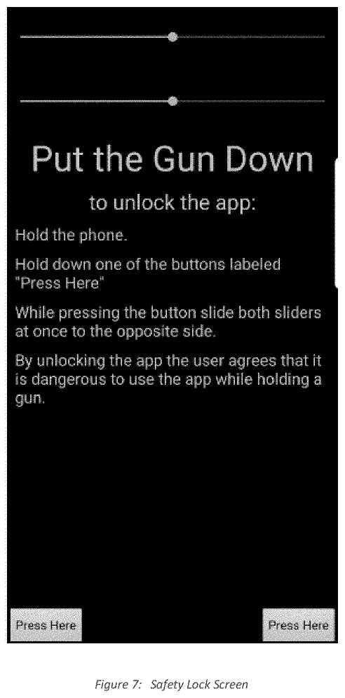

As the collection segment may operate in range and other settings where loaded guns are present, a concern regarding the safety of a shooter actions while attempting to operate a target collection capability and a loaded weapon simultaneously is obvious to a casual observer. Attention drawn from the safe handling of the weapon could cause an unintentional and potentially harmful including the possibility of fatal discharge. The initial embodiment of the collection segment employs a safety feature to ensure temporal separation of handling of a weapon and handling of the mobile device. The initial embodiment employs a method to use position/pose information available from the device to lock the application after a specific period of time, and require the shooter to use two hands on the mobile device to unlock to access the application. The lock screen associated with this mechanism is shown in FIG. 7. Additional embodiments include using any available camera to collect images and understand the location, pose, and other states of a weapon or weapons or individuals, using fingerprint scanners to ensure specific fingers are placed on the device, or using accelerometers to force specific movement of the device attainable only with two hands.

In the server(s) segment shown in FIG. 1, the ‘datastore—metadata’ portion comprises a datastore capable of storing and providing limited processing on the metadata associated with the subject target-sport. The datastore-images' portion comprises a datastore capable of storing images. The separation of datastore-metadata and datastore-images provides an economic advantage in implementation that would not be possible using contemporary database technology, thus we employ the term ‘datastore’ to separate both the initial embodiment and any subsequent similar embodiments employing separated storage capabilities from a contemporary ‘database’. The ‘process/reprocess’ portion comprises a capability to interpret both metadata and image data, as well as to refine metadata after initial collection based on improved processing, analytics, interpretation, and displays over time. The ‘analytics’ portion comprises a set of analytic techniques including processing (multiple combinations of mathematical and algorithmic manipulation), storage, and display, associated with individual and ad hoc groups to produce information of interest to an individual, or to a group or organization.

An additional scoring mode associated with training can be used to validate target shooters using other-than-bullring targets. Similar image-processing algorithms to those detailed in [00025] above can be used to detect the number of holes inside a known specific outline. Such methods can be integrated with the datastores above to produce training sets for law enforcement individuals who need to validate their training to authorities. In this case, each hole within a perimeter (an arbitrary polygon) detected scores a unit value, distinct from having a distance metric change the value score.

In the analytic segment shown in FIG. 1, the ‘display’ portion comprises displays developed for individuals who are other than the original target collector (as examples, a professional trainer, a friend, a relative, an organization, or a group of like-minded target shooters—but not limited to any of these examples). The ‘analytics’ portion contains analysis methods, algorithms, and software provisioned for individuals including both the original target collector and other individuals. The ‘ad hoc groups’ portion comprises display and analytic software associated with the formation of ad hoc groups—such groups may be physically co-located or remote and may include both real and virtual participants.

In the group segment shown in FIG. 1, the ‘group analytics’ portion comprises analytic algorithms, methods, and sharing communication methods for groups of target-sport participants. Such groups may be organized around training, competition, social or professional clubs, government organizations, political or nation-state entities, geospatial regions or any other group however formally or informally organized. The ‘group displays’ portion comprises algorithms and methods associated with processing group data surrounding displays of group target-sports. The ‘group discovery’ portion comprises analytic capabilities that discover pattern data within individual and group target-sport data that has value to organized groups. The ‘social media and interaction’ portion comprises group functions including commenting amongst individuals and groups, provisioning for integrated manual or automatic information sharing with contemporary social media platforms, and associated display in individual or group contexts.

In FIG. 2, a display of an initial embodiment of a subset of the collection segment is shown. FIG. 2 depicts a mobile device with a subset of the invention software depicting a target, surrounded by control and information provisioning information. A control element is depicted in the upper left. A social media interaction element is depicted near the top center. A manual editing capability is depicted in the upper right. A notional target is depicted near the center. Live or near-real-time feedback scoring mechanisms are shown near the top of the target. Fiducials for spatially registering the mobile device with the target are provided, including a centering dot shown in yellow. Automatic scoring rings surround target holes and are depicted in red in this initial embodiment. Control mechanisms for additional functions appear below the target image area. The mobile device operating capabilities at the top and bottom of the display are persevered. Not viewable due to the static nature of the provisional patent application is the fact that the image was captured as part of a live-feedback session with video being display of the target, and live registration and scoring information being updated in real time. Also not viewable in FIG. 2 is that the capture images are relayed to servers in near-real-time without operator input, a safety feature that prevents distractions from causing target-scoring safety issues present at many targeting venues.

Analytic features, which can be utilized in any of the four invention segments, include at least bias calculations, variance calculation using sample mean, variance calculations using trending means, confidence interval calculations considering fixed or variable numbers of targets, minimum and maximum target spread functions, hole counting functions, aspect ratio and elliptical axis angle calculations, histogram analysis of sessions across above variables, statistical prediction of future session mean and variance calculations, handicapping of results for purposes of training or competition, median filter processed results, short and long term statistical calculations, temporal trending calculations of bias, variance, ellipse shapes, handicaps, training results, temporally-trended bias direction analytic depictions, and competition results. For comparison of results with other individuals, groups, and organizations, the initial embodiment contains at least: comparison of individuals against group statistics, comparisons of groups w.r.t. other groups, comparisons of organizations w.r.t. other organizations, comparisons of geospatial regions, comparison of individual, group, or organization performance against time and against session index, comparison of competition results by individual, group, or organization in any combination.

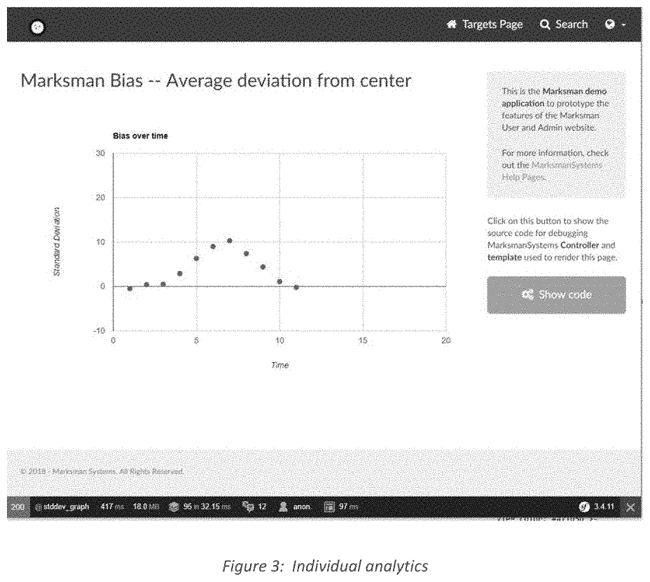

FIG. 3 shows an initial embodiment of the server analytics capability, showing target metadata associated with a captured image. The image and the metadata are juxtaposed on the same display. A social media interaction capability is shown at the bottom of the display, allowing commenting on targets by other users. Control information depicted at the top of FIG. 3 allows for accessing other portions of the server segment analytics, processing, and datastore areas of the invention.

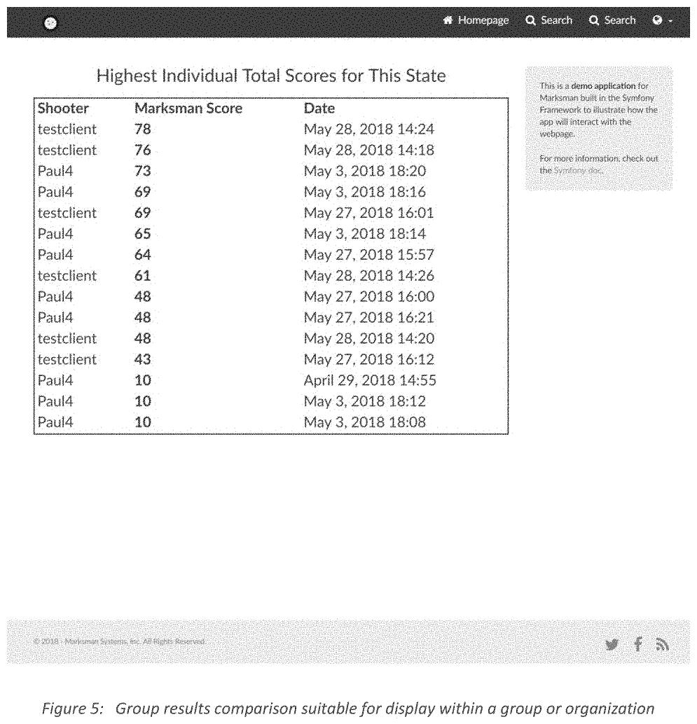

FIG. 5 shows a comparison of aggregated scores for the state of Georgia along with identification of user who captured the target at the date and time of capture. Displays incorporating group or organization comparison analytics are relevant for display in group or organization venues.

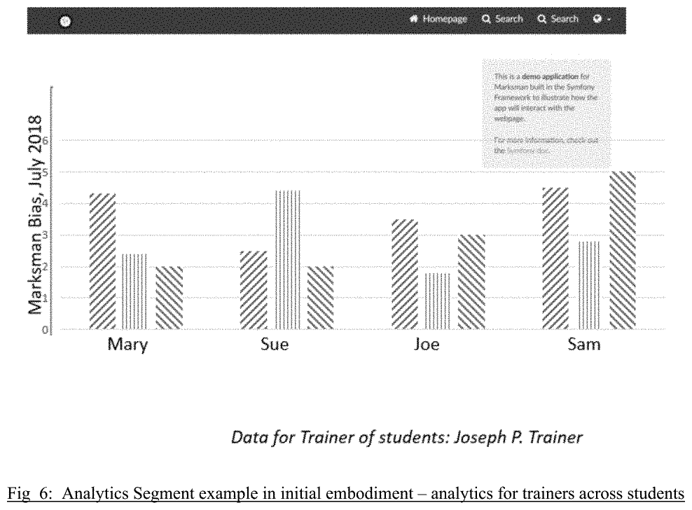

FIG. 6 shows an initial embodiment of group analytics provided for trainers to compare student performance. Additional embodiments may include group comparison along temporal, regional, club-based, nation-state-based, or other comparison methods.

FIG. 7 depicts the lock screen shown, that requires the user to place fingers on separated parts of the display to ensure two hands are on the device simultaneously.

What is claimed is:

1. An automated integrated information management system for individuals, groups, and organizations involved in one or more target sports comprising:
a. a collection segment,
b. a server segment,
c. an analytic segment,
d. group/organization segment.

2. The automated integrated information management system as in claim #1, whereby a collection segment including a live-video-feedback element implementable in contemporary mobile devices employing electro-optic or infrared cameras and other sensors, or in purpose-built hardware and software, is used to automatically collect target sport information.

3. The automated integrated information management system as in claim #1, whereby a server segment including separate datastores for target metadata and images to realize an economic and scalable implementation, automatically integrates with the collection segment of this invention.

4. The automated integrated information management system as in claim #1, whereby an A analytic segment allows secondary target-sport participants to access select target-score and analytic information.

5. The automated integrated information management system as in claim #1, whereby a group/organization segment including processing, analytics, storage, display, and dissemination capability for target sport data, as well as a social media interaction and interaction capability is realized.

6. A safety mechanism employing one or more sensors available on a mobile device including at least displays, touch, accelerometer, and one or more cameras, that ensures a user has two hands on the device for some prescribed length of time and additionally requiring the user to perform an interactive function verifying two handed-operation.
